(19) United States
(12) Patent Application Publication
(10) Pub. No.: US 2003/0035568 A1
(43) Pub. Date: Feb. 20, 2003

(54) User interface including multifunction fingerprint roller and computer including the same

(76) Inventors: Mitko G. Mitev, Corvallis, OR (US); Memphis Zhihong Yin, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/933,220

(22) Filed: Aug. 20, 2001

(51) Int. Cl. G06K 9/00; G09G 5/08

(52) U.S. Cl. 382/124; 345/167

(57) ABSTRACT

A user interface including an at least partially transparent roller. The transparency allows the roller to be used as part of a fingerprint scanning system during fingerprint scans. The roller may also be used for other purposes during non-scanning periods. For example, the roller may be used in place of a conventional scroll key to control scrolling.

### BACKGROUND OF THE INVENTIONS

1. Field of the Inventions

The present inventions are related to computers and, more specifically, user interfaces including fingerprint sensors.

2. Description of the Related Art

Computers, which allow people to easily perform tasks such as word processing, spreadsheet calculations, database manipulation, e-mail message transmission, internet searches for information, and connecting to networks, have become ubiquitous in recent years. Mainframe computers tend to be relatively large and expensive devices capable of supporting hundreds, or even thousands, of users simultaneously. Each user is typically provided with a visual display and a user interface, such as a keyboard, that are connected to the mainframe. Personal computers, on the other hand, are relatively inexpensive devices designed for an individual user. They also have visual displays and user interfaces—typically a keyboard, mouse and/or any other device that is pressed, moved or otherwise manipulated in order to control some aspect of the operations of the computer.

Personal computers were initially desktop devices. However, the fact that they have become such an integral portion of the average person's life has led to the development of portable computers, such as laptop and notebook computers. Portable computers have proven to be a significant advance because they are relatively small (i.e. about 13 inches wide, 10.5 inches long and 1.5 inches high) and lightweight (i.e. about 5 lbs.). More recently, a variety of hand-held (or palm sized) portable computers have been introduced. As a result, people are able to easily transport portable computers to remote locations where they can perform the same tasks previously performed using only relatively immobile desktop computers. These tasks include connecting to a network of other computers. Notebooks and other portable computers often include a display and keyboard, as well as click buttons, scroll keys and touch pads that together perform the functions of a mouse.

Computers and computer networks are now used to store and manipulate a wide variety of sensitive information such as financial data, customer lists and other trade secrets, medical records and other personal information, etc. They are also integral to the day to day operations of most businesses. Accordingly, one issue that has grown in parallel with the use of computers is computer security. Preventing unauthorized access to a computer or private network of computers, as well as to the data stored therein, is of paramount importance. This problem is magnified in the case of portable computers because they are frequently stolen.

In the past, conventional security systems employed alpha-numeric passwords to identify authorized users and regulate access to computers and computer networks. Passwords have proven to be inconvenient because people have been forced to remember a variety of passwords associated with different aspects of their personal and professional lives. Users also forget passwords. Passwords are also somewhat ineffective because users frequently create passwords that correspond to personal information, such as a birthday or name, that is relatively easy for hackers and thieves to uncover. Password lists may also be stolen.

More recently, security systems that check fingerprints and other biometric information to identify authorized computer users have begun to replace password-based systems. Here, a keyboard, mouse or other user interface is provided with fingerprint scanning hardware and a fingerprint sized scanning window upon which the prospective user places a finger. The scanning hardware scans the fingerprint and captures a fingerprint image. The security system then determines whether or not the fingerprint image corresponds to that of an authorized user. If it does, access is permitted. If not, access is denied.

The inventors herein have determined that conventional fingerprint scanning systems are susceptible to improvement. For example, the inventors herein have determined that conventional fingerprint scanning windows occupy an inordinate amount of what, in many instances, is limited user interface surface area.

### SUMMARY OF THE INVENTIONS

A user interface in accordance with one embodiment of a present invention includes an at least partially transparent roller. The transparency allows the roller to be used as part of a fingerprint scanning system during fingerprint scans. The roller may also be used for other purposes, such as controlling one or more aspects of the operation of the computer system, during non-scanning periods. For example, the roller may be used in place of a conventional scroll key to control scrolling. As such, the present user interface allows a device necessary for fingerprint scanning to be added to a user interface without increasing the numbers of user interface elements or the surface area occupied thereby.

### BRIEF DESCRIPTION OF THE DRAWINGS

Detailed description of preferred embodiments of the inventions will be made with reference to the accompanying drawings. Certain aspects of the preferred embodiments have been eliminated from some or all of the views for clarity.

FIG. 1 is a perspective view of a portable computer in accordance with a preferred embodiment of a present invention.

FIG. 2 is a block diagram showing various operating components of a portable computer in accordance with a preferred embodiment of a present invention.

FIG. 3 is a perspective view of a user interface in accordance with a preferred embodiment of a present invention.

FIG. 4 is a side, partial section view of a portion of the exemplary portable computer illustrated in FIG. 1.

FIG. 5a is an end view of a roller in accordance with a preferred embodiment of a present invention.

FIG. 5b is a plan view of a roller and rotational motion sensor in accordance with a preferred embodiment of a present invention.

FIG. 6 is a perspective view of a mouse in accordance with a preferred embodiment of a present invention.

FIG. 7 is a side, partial section view of the mouse illustrated in FIG. 6.

FIG. 8 is a block diagram showing various operating components of a mouse in accordance with a preferred embodiment of a present invention.

### DETAILED DESCRIPTION OF THE PREFERRED EMBODIMENTS

The following is a detailed description of the best presently known modes of carrying out the inventions. This description is not to be taken in a limiting sense, but is made merely for the purpose of illustrating the general principles of the inventions. Additionally, it is noted that detailed discussions of various conventional internal operating components of computers and user interfaces which are not pertinent to the present inventions have been omitted for the sake of simplicity.

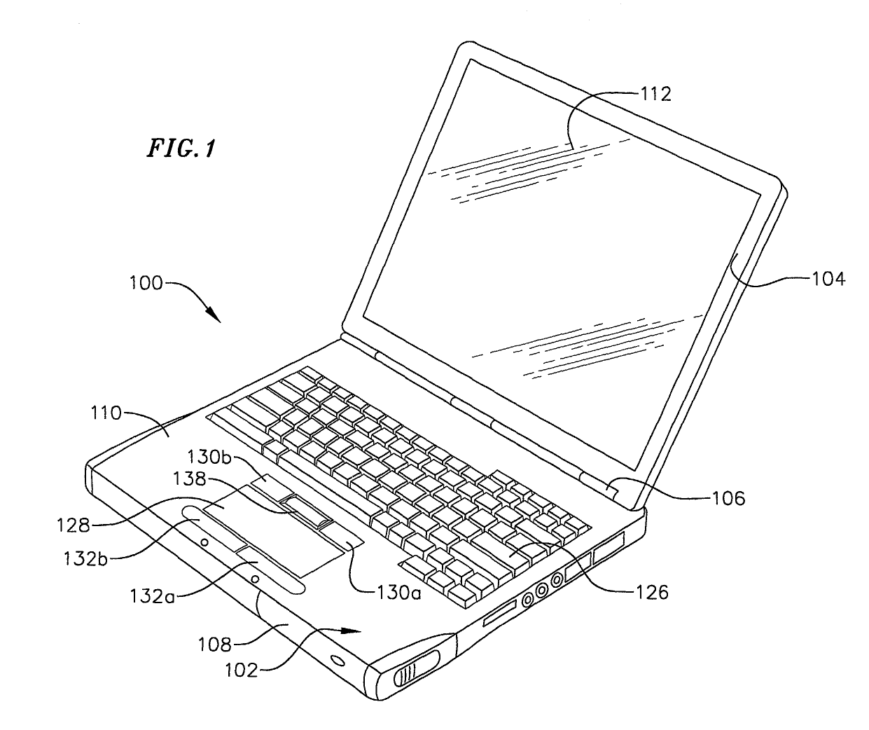

Although not limited to any particular style of computer, one embodiment of a present invention is the exemplary notebook style portable computer 100 illustrated in FIGS. 1-4. The exemplary portable computer 100 is, with respect to many of the structural and operating components, substantially similar to conventional portable computers such as the Hewlett-Packard Omnibook 6000 notebook PC. More specifically, the exemplary portable computer 100 includes structural components such as a main housing 102 and a display housing 104 that is pivotably connected to the main housing by a hinge 106. The main housing 102 includes a module bay for optional modules such as the illustrated CD-ROM drive module 108, a 3.5 inch disk drive module, or a ZIP drive module, and a battery bay (not shown). The exemplary main housing 102, which in the illustrated embodiment is approximately 13 inches wide, 10.5 inches long and 1.5 inches high, is also provided with a user interface 110 that allows the user to interact with the computer 100. The user interface 110 is discussed in greater detail below. In addition to supporting a display 112, the display housing 104 also acts as a lid to cover the user interface 110 when in the closed position. To that end, a conventional latch arrangement (not shown) may be provided to lock the free end of the display housing 104 to the main housing 102 and maintain the display housing in the closed position.

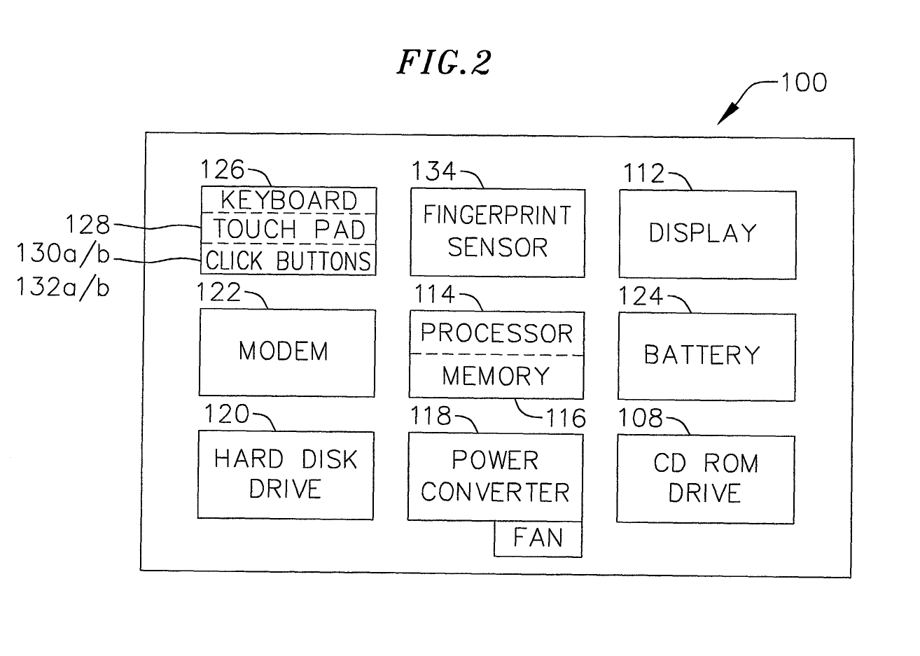

As illustrated in block diagram form in FIG. 2, the operating components of the exemplary computer 100 include a CPU (or “processor”) 114, cache and RAM memory 116, a power adapter and fan arrangement 118, a hard disk drive 120, a modem 122, and a battery 124 positioned within the battery bay. The exemplary portable computer 100 may also include other conventional components such as, for example, audio and video cards, headphone and microphone ports, serial, parallel and USB ports, keyboard and mouse ports, a

240-pin PCI connector for docking, an operating system such as Microsoft® Windows, and various application programs such a word processing, spreadsheets, security programs and games.

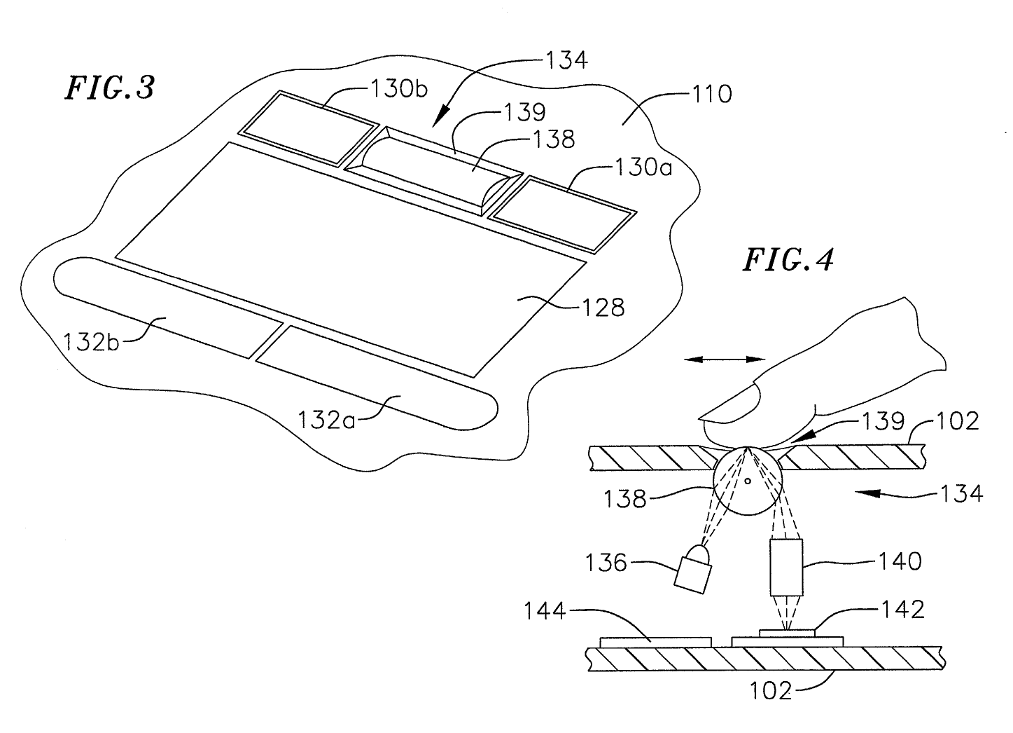

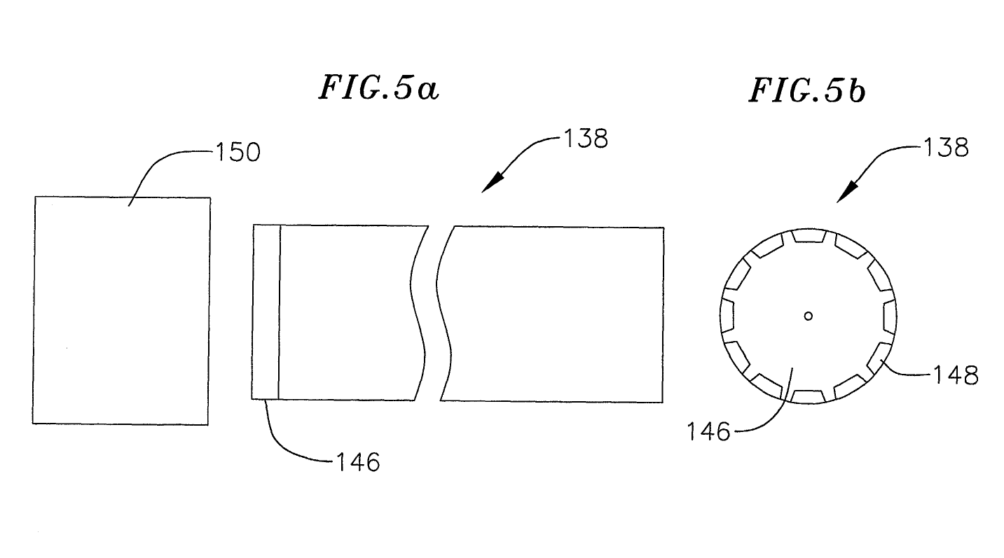

The user interface 110 in the exemplary computer 100 illustrated in FIGS. 1-4 includes a keyboard 126, a touch pad 128, a first pair of right/left click buttons 130a/130b and a second pair of right/left click buttons 132a/132b. [Note FIGS. 1 and 3.] Each of these elements operates in conventional fashion to control the operations of the computer 100 and application programs running thereon. Referring more specifically to FIGS. 3 and 4, the exemplary user interface 110 is also provided with a fingerprint sensor 134. In the illustrated embodiment, the fingerprint sensor 134 includes a light source 136, a multi-purpose transparent roller 138, a lens 140 and a light sensor 142. The roller 138 extends through an opening 139 in the main housing 102. The computer 100 also includes a rotational motion detection mechanism (discussed below with reference to FIGS. 5a and 5b) to detect the rotational motion, i.e. speed and direction of the roller 138. In the illustrated embodiment, the rotational motion data may be used in combination with data from the light sensor 142 during a fingerprinting operation. The light source 136 and light sensor 142 are connected to a controller 144. The rotational motion detection mechanism may also be connected to the controller 144, depending on the control configuration employed. During use, light from the source 136 is directed through the transparent roller 138 onto a moving finger that is in contact with the roller and causing it to rotate. Light is reflected by the finger back through the transparent roller 138 to the lens 140, where it is focused onto the light sensor 142 to produce fingerprint image data.

The fingerprint data, i.e. fingerprint image data and rotational motion data, may then be transferred to processor 114 for processing in conventional fashion. Such processing would typically involve the formulation of a facsimile of the scanned fingerprint from the fingerprint data and a comparison of the scanned fingerprint to a known fingerprint. Alternatively, the controller 144 may be provided with sufficient processing capabilities to provide other types of fingerprint data to the associated computer processor 114. Such other types of fingerprint data may be in the form of, for example, a completed facsimile of the scanned fingerprint itself. The controller 144 could, alternatively, be capable of using the rotational motion data to control the taking of the fingerprint image data such that the fingerprint data need only include image data from the fingerprint scan, albeit in a predetermined form that may be used by the security program without the rotational motion data.

With respect to the individual components of the exemplary fingerprint sensor 134, in the example of FIG. 4, a suitable light source (136) is an LED. The roller 138 should be formed from material such as glass or plastic that is transparent, or at least has sufficient transparency to function properly in the fingerprint sensor 134. In addition to a conventional glass lens, the lens 140 may also be a SELFOC™-type lens. The light sensor 142 is preferably a linear imaging CCD, CMOS sensor, or a contact image sensor.

The rotational motion of the roller 138 may be monitored in a variety of ways. For example, an encoder wheel 146 with slots 148 may be provided on one end of the roller 138, as shown in FIGS. 5a and 5b, with a rotational motion sensor 150 provided in close proximity. Alternatively, bumps or pits which can be detected by both mechanical and optical devices, may be provided on one end of the roller 138. Another detection scheme involves the use of a series of optical markings or decals, the movement of which may be detected by the light sensor 142 when the light source 136 is emitting light, which are positioned near one of the longitudinal ends of the roller 138. An encoder wheel and motion sensor may also be spaced apart from the roller 138, with the encoder wheel connected to the roller by one or more gears and/or belts.

In addition to forming a portion of the fingerprint sensor 134, the multipurpose roller 138 in the exemplary user interface 110 may be used to control some aspect of the operations of the computer and associated application programs in the same manner as a conventional roller. For example, the roller 138 may be used for scrolling, i.e. moving an image vertically or horizontally on the display 112 so that new portions of the image appear at one edge as previous portions of the image disappear at the opposite edge.

Accordingly, with respect to the multi-purpose roller 138, the exemplary computer 100 and user interface 110 have at least two modes of operation—the fingerprint mode and the roller mode. In the fingerprint mode, the fingerprint sensor 134 is operational and provides fingerprint data to the processor 114. As noted above, depending on the relative processing loads being carried by the processor 114 and controller 144, the fingerprint data may include any one of (1) fingerprint image data and rotational motion data, (2) data corresponding to completed facsimile of the fingerprint image, or (3) fingerprint image data that may be used by the processor 114 without rotational motion data. The fingerprint mode may be initiated by variety of predetermined commands. For example, a security program that runs during the computer start-up process could initiate the fingerprint mode. Such a security program would require the user to provide a fingerprint before access to the programs and data stored on computer will be granted. Such a security program could also be initiated only when access to certain programs or data is requested, or when required by a network server or other remote device to which the computer 100 is connected. Fingerprint sensing could also be activated in response to the actuation of a predetermined key or keys (e.g., Shift-Alt-F).

In the roller mode, only those elements required for a roller function such as scrolling should be operable. Thus, the computer 100 need only monitor the rotational motion of the roller 138 with, for example, the rotational motion sensor/encoder 150 so that the user can scroll through data. The light source 136 and light sensor 142 would not be operational (unless they were being used to monitor the rotation of the roller 138). Preferably, the roller mode will be the default mode once the computer 100 has completed the start-up process, including running any security programs required to permit access to the computer.

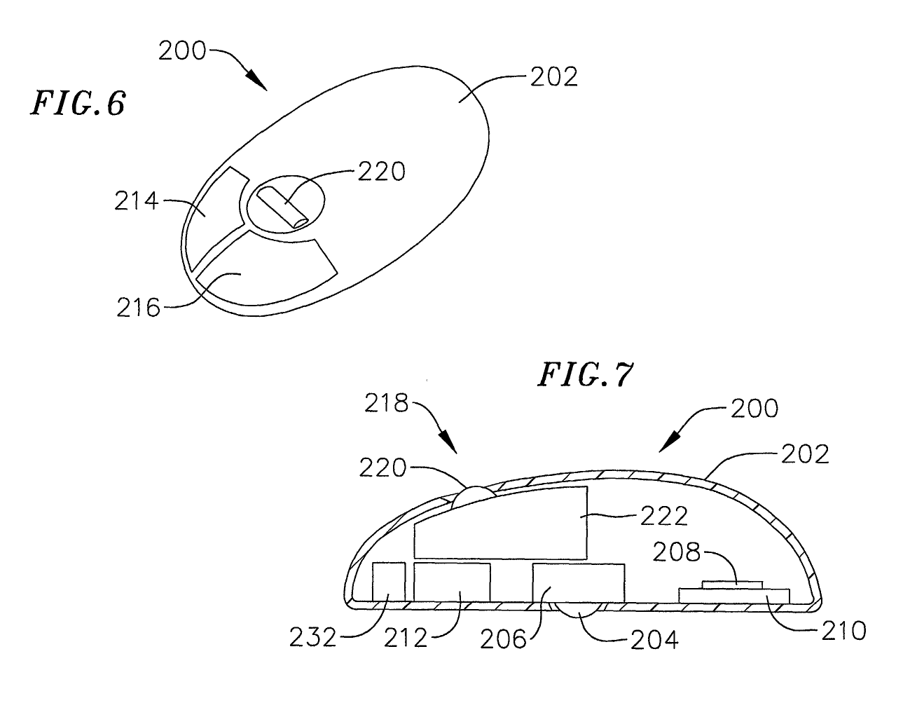

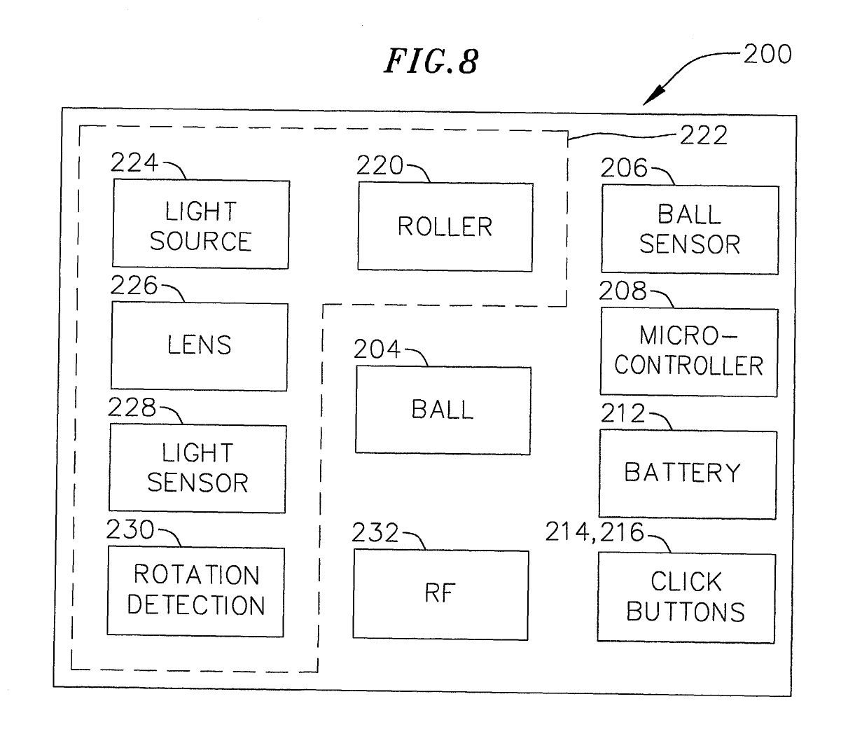

Turning to FIGS. 6-8, a user interface in accordance with another preferred embodiment of a present invention is in the form of a computer mouse 200. The mouse 200 includes a housing 202 and a system for sensing the movement of the mouse relative to the surface on which it is being used when. The exemplary embodiment includes a conventional rotatable ball 204 and sensor 206 arrangement. Alternatively, an optical system, such as that found in the Microsoft® IntelliMouse® optical mouse, may be provided to sense the movement of the mouse. The exemplary mouse 200 also includes a microcontroller 208 that is mounted on a circuit board 210, which includes memory and other conventional devices. Power is supplied by a battery 212. The data provided by the sensor 206 is used by software in the associated computer to perform particular functions, such as repositioning a cursor on the display.

The exemplary mouse 200 illustrated in FIGS. 6-8 is also provided with a pair of click buttons 214 and 216 and a fingerprint sensor 218. Movement of the click buttons 214 and 216 controls some aspect of the operations computer and associated application software programs in conventional fashion. The fingerprint sensor 218, which is substantially similar to the fingerprint sensor 134 described above, includes a multi-purpose transparent roller 220 and a sensor housing 222. Various components, such as light source 224, lens 226, light sensor 228 and rotational detection mechanism 230, are located within the housing 222. These components may, however, be rearranged into a horizontally extending arrangement to compensate for the size and shape of the mouse 200. The appropriate components are connected to the microcontroller 208. In addition to being used in a fingerprint scanning operation, the multipurpose roller 220 may be used to control some aspect of the operations computer and associated application software programs in conventional fashion.

In the illustrated embodiment, the mouse 200 is a wireless device that communicates with a computer without being physically connected by a communication cable. Such communication may take place through the use of, for example, high frequency, radio frequency (RF), or infrared communication signals. RF signals are used in the illustrated embodiment and, to that end, the mouse 200 is provided with a RF transmission apparatus 232 that is suitable for use in a wireless peripheral device. Such RF transmission apparatus typically include a frequency synthesizer that is controlled by the microcontroller 208, a RF amplifier and an antenna. One example of a RF transmission apparatus that is suitable for use in a wireless peripheral device is disclosed in U.S. Pat. No. 5,854,621. Alternatively, the mouse 200 may instead be connected to the associated computer with a communication cable (not shown).

With respect to the multipurpose roller 220, the mouse 200 also has at least two modes of operation—the fingerprint mode and the roller mode. In the fingerprint mode, the fingerprint sensor 218 is operational and provides fingerprint data to, for example, the processor of the associated computer. The fingerprint mode may, for example, be initiated by a security program running on the associated computer, by a button (not shown) on the mouse 200, or in response to the actuation of a predetermined key or keys (e.g., Shift-Alt-F) on the associated computer. The operation of the click buttons 214 and 216 and their effect on the associated computer/software application programs would preferably, although not necessarily, be the same in both the fingerprint mode and the roller mode. However, in the roller mode, only the rotational motion of the roller 220 is monitored so that the rotational motion can be used by the associated computer to, for example, control scrolling functions. Preferably, the roller mode will be the default mode of operation.

In those instances where a depressible roller 220 is desired for additional functionality, the housing 222 may be mounted above a contact plate on one or more upward biasing springs (or other devices) in the same manner as a conventional mouse with a depressible roller. When a downward force sufficient to overcome the biasing force is applied to the roller 220, the housing will 222 will engage the contact plate.

Although the present inventions have been described in terms of the preferred embodiments above, numerous modifications and/or additions to the above-described preferred embodiments would be readily apparent to one skilled in the art.

By way of example, a user interface in accordance with a present invention may be in the form of a stand alone computer keyboard, such as those commonly used in conjunction with a conventional personal computer. Here, a fingerprint sensor with a multi-purpose transparent roller would be located on the keyboard housing adjacent to, for example, the arrow keys.

It is intended that the scope of the present inventions extend to all such modifications and/or additions.

What is claimed is:

1. A user interface for use with a computer, comprising:
an at least partially transparent roller; and
a sensor system, associated with the transparent roller, operable in a first mode to sense the image of a fingerprint and operable in a second mode to sense the rotational motion of the roller.

2. A user interface as claimed in claim 1, further comprising:
at least one manually actuatable element.

3. A user interface as claimed in claim 2, wherein the at least one manually actuatable element comprises a button.

4. A user interface as claimed in claim 2, wherein the at least one manually actuatable element comprises a pair of buttons located on opposite sides of the roller.

5. A user interface as claimed in claim 2, wherein the at least one manually actuatable element comprises a plurality of keys together defining a keyboard.

6. A user interface as claimed in claim 2, wherein the at least one manually actuatable element comprises a touch pad.

7. A user interface as claimed in claim 1, wherein the sensor system includes a light sensor and a light source that emits light which passes through the roller.

8. A user interface as claimed in claim 1, further comprising:
a movement tracking device that tracks the movement of the user interface as it is moved over a surface.

9. A user interface for use with a computer, comprising:
an at least partially transparent roller;
a light source that emits light which passes through the roller;
a light sensor that receives reflected light;
a rotational motion sensor associated with the roller that senses rotational motion of the roller; and
a control system, associated with the light source, light sensor and rotational motion sensor, the control system being operable in a first mode to enable operation of the light source, light sensor and rotation motion sensor and operable in a second mode to enable operation of the rotation motion sensor and disable operation of at least one of the light source and at least a portion of the light sensor.

10. A user interface as claimed in claim 9, further comprising:
at least one manually actuatable element.

11. A user interface as claimed in claim 10, wherein the at least one manually actuatable element comprises a button.

12. A user interface as claimed in claim 10, wherein the at least one manually actuatable element comprises a pair of buttons located on opposite sides of the roller.

13. A user interface as claimed in claim 10, wherein the at least one manually actuatable element comprises a plurality of keys together defining a keyboard.

14. A user interface as claimed in claim 10, wherein the at least one manually actuatable element comprises a touch pad.

15. A user interface as claimed in claim 9, further comprising:
a movement tracking device that tracks the movement of the user interface as it is moved over a surface.

16. A computer system, comprising:
a user interface including an at least partially transparent roller;
an image sensor associated with the roller that senses the image of a fingerprint and generates fingerprint image data;
a rotational motion sensor associated with the roller that senses rotational motion of the roller and generates roller motion data; and
a control system associated with the image sensor and rotational motion sensor, the control system being operable in a first mode to convert the fingerprint image data and rotational motion data into data representative of the scanned fingerprint and operable in second mode to control an operation of the computer system in response to the roller motion data.

17. A computer system as claimed in claim 16, wherein the control system comprises at least one processor.

18. A computer system as claimed in claim 17, further comprising:
a computer housing in which the processor is located.

19. A computer system as claimed in claim 18, further comprising:
a display pivotably connected to the computer housing.

20. A computer system as claimed in claim 18, wherein the user interface is mounted on the computer housing.

21. A computer system as claimed in claim 17, further comprising:
a user interface housing separate from the computer housing.

22. A computer system as claimed in claim 16, wherein the user interface includes a touch pad and buttons.

23. A computer system as claimed in claim 16, wherein the user interface includes a keyboard.

24. A computer system as claimed in claim 16, wherein the image sensor comprises:
a light source that emits light which passes through the roller; and
a light sensor that receives light reflected through the roller.

25. A computer system as claimed in claim 24, wherein the control system disables at least one of the light source and at least a portion of the light sensor in the first mode.

26. A computer system as claimed in claim 16, wherein the operation of the computer system comprises a scrolling operation.

27. A method of operating a computer system including an at least partially transparent roller, the method comprising the steps of:
receiving data corresponding to rotational motion of the roller;
using the data corresponding to rotational motion of the roller to generate data corresponding to a fingerprint when the computer system is in a fingerprint scanning mode; and
using the rotational motion of the roller to control a predetermined aspect of computer system operation when the computer system is not in the fingerprint scanning mode.

28. A method as claimed in claim 27, wherein the predetermined aspect of the computer system operation comprises scrolling.

29. A method as claimed in claim 27, further comprising the steps of:
directing light through the at least partially transparent roller onto a finger during the fingerprint scanning mode;
sensing light reflected by the finger;
generating data corresponding to the light reflected by the finger; and
using the data corresponding to the light reflected by the finger to generate data corresponding to a fingerprint.
